(19) United States
(12) Patent Application Publication
(10) Pub. No.: US 2011/0318634 A1
(43) Pub. Date: Dec. 29, 2011

(54) SECONDARY BATTERY

(75) Inventors: Hwa-Il UH, Yongin-si, (KR); Kyoung-Han KIM, Yongin-si, (KR)

(73) Assignee: SAMSUNG SDI CO., LTD., Yongin-si (KR)

(21) Appl. No.: 12/898,194

(22) Filed: Oct. 5, 2010

Related U.S. Application Data
(60) Provisional application No. 61/358,506, filed on Jun. 25, 2010.

(51) Int. Cl. H01M 2/04; H01M 2/02

(52) U.S. Cl. 429/178

(57) ABSTRACT

A secondary battery having a cap assembly that prevents the end of the terminal plate from coming undone or detached by forming a fixing member having a hook shape at an insulating plate such that the terminal plate is retained by the fixing member. The cap assembly includes a fixing member having a hook shape on the bottom of an insulating plate positioned between a cap plate and a terminal plate, in which the terminal plate is retained by the fixing member. According to this configuration, it is possible to improve weldability between the electrode tabs drawn out of the electrode assembly and the terminal plate.

### CLAIM OF PRIORITY

This application claims priority to and the benefit of Provisional Application No. 61/358,506, filed on Jun. 25, 2010, in the United States Patent and Trademark Office, the entire content of which is incorporated herein by reference.

### BACKGROUND

1. Field of the Invention

Aspects of the present invention relate to a secondary battery.

2. Discussion of Related Art

In general, rectangular lithium secondary batteries may be formed by accommodating an electrode assembly in a can, in which the electrode assembly includes a negative plate having a negative tab, a positive plate having a positive tab, and a separator interposed therebetween.

The above information disclosed in this Related Art section is only for enhancement of understanding of the background of the invention and therefore it may contain information that does not form the prior art that is already known to a person of ordinary skill in the art.

### SUMMARY OF THE INVENTION

Aspects of the present invention provide a fixing member (latch or catch) having a hook shape to an insulating plate positioned between a cap plate and a terminal plate to fix the terminal plate to the fixing member. This aspect of the present invention provides for a secondary battery that can prevent the end of the terminal plate from coming undone or detached.

Another aspect of the present invention includes a cap assembly having a cap plate attached to an insulating case of a secondary battery. The cap assembly includes a terminal plate positioned between the cap plate and the insulating case. Also included is an insulting plate having an upper surface facing the cap plate and a lower surface facing a base of the insulating case. At least one fixing member extends from the lower surface of the insulating plate holding the terminal plate to the insulating plate.

Another aspect of the present invention includes provides for the at least one fixing member is hook-shaped.

Still another aspect of the present invention includes the insulating plate having four edges, said four edges including two long side surfaces and two short side surfaces.

Still another aspect of the present invention provides for the at least one fixing member to extend from the lower surface of the insulating plate opposite to a side surface where a hole is located near.

Still another aspect of the present invention provides for the insulating plate to have four edges. The four edges include two short side surfaces and no long side surfaces, in which the at least one fixing member extends from the lower surface of the insulating plate nearest to one of the two short side surfaces and opposite to another side surface where a hole is located near.

Still another aspect of the present invention provides for at least two fixing members with one of the two fixing members being nearest to one of the two long side surfaces and another of the at least two fixing members being nearest to another of the two long side surfaces.

Still another aspect of the present invention provides for at least three fixing members with one of the three fixing members being nearest to one of the two long side surfaces, another of the at least three fixing members being nearest to another of the two long side surfaces and another of the at least three fixing members being nearest to one of the two short side surfaces.

Still another aspect of the present invention provides for the at least one fixing member to include a support extending from the at least one fixing member to form a hook-shaped structure. The support includes a traverse surface that is parallel to the lower surface of the insulating plate forming a guide groove and a tapered surface inclined at an acute angle to the lower surface of the insulating plate.

Still another aspect of the present invention provides for the terminal plate to include a locking groove recessed in the terminal plate having a shape to accommodate the support.

Still another aspect of the present invention provides for the insulting plate to include a receiving space in the lower surface to accommodate the terminal plate.

Still another aspect of the present invention provides for the insulating plate to be partially surrounded by either the short side walls or the long side walls and fixing member extends from either the short side or long side walls.

Another aspect of the present invention provides for a secondary battery having a cap assembly and a can, the cap assembly having a cap plate with an electrode terminal extending through the cap plate, the cap plate is attached to an insulating case, the insulating case is further attached to the can, the can having an electrolyte and an electrode assembly, the electrode assembly having a negative and positive tab. The cap assembly includes a terminal plate having a second terminal hole through which the electrode terminal passes, the terminal plate is positioned between the cap plate and the insulating case. Also included is an insulting plate having an upper surface facing and in contact with the cap plate and a lower surface in contact with the terminal plate and facing a base of the insulating case. At least one fixing member extending from the lower surface of the insulating plate holding the terminal plate to the insulating plate.

Still another aspect of the present invention provides for the at least one fixing member being hook-shaped.

Still another aspect of the present invention provides for the insulating plate to have four edges. The four edges include two long side surfaces and two short side surfaces.

Still another aspect of the present invention provides for the at least one fixing member to extend from the lower surface of the insulating plate opposite to a side surface where a hole is located near.

Still another aspect of the present invention provides for the insulating plate to have four edges. The four edges include two short side surfaces and no long side surfaces. The at least one fixing member extends from the lower surface of the insulating plate nearest to one of the two short side surfaces and opposite to another side surface where a hole is located near.

Yet another aspect of the present invention provides for at least two fixing members with one of the two fixing members being nearest to one of the two long side surfaces and another of the at least two fixing members being nearest to another of the two long side surfaces.

Still another aspect of the present invention provides for at least three fixing members with one of the three fixing members being nearest to one of the two long side surfaces, another of the at least three fixing members being nearest to another of the two long side surfaces and another of the at least three fixing members being nearest to one of the two short side surfaces.

Still another aspect of the present invention provides for the at least one fixing member to further include a support extending from the at least one fixing member to form a hook-shaped structure. The support includes a traverse surface that is parallel to the lower surface of the insulating plate forming a guide groove and a tapered surface inclined at an acute angle to the lower surface of the insulating plate.

Still another aspect of the present invention provides for the terminal plate to further include a locking groove recessed in the terminal plate having a shape to accommodate the support.

Still another aspect of the present invention provides for the insulting plate to further include a receiving space in the lower surface to accommodate the terminal plate.

Still another aspect of the present invention provides for the insulating plate to partially surround either the short side walls or the long side walls and the fixing member to extend from either the short side or long side walls.

As described above, according to aspects of the present invention, it is possible to improve weldability between the electrode tabs drawn out of the electrode assembly and the terminal plate, by retaining the terminal plate with the fixing member of the insulating plate such that the end of the terminal plate is prevented from coming undone.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a rectangular secondary battery according to an embodiment of the present invention;

FIG. 2 is a partial cross-sectional view of a secondary battery equipped with an insulating plate having a fixing member according to the embodiment of the present invention shown in FIG. 1;

FIG. 3 is a bottom view of the insulating plate having the fixing member according to the embodiment of the present invention shown in FIGS. 1 and 2;

FIG. 4 is a bottom view of an insulating plate having a fixing member according to another embodiment of the present invention;

FIG. 5 is a bottom view of an insulating plate having a fixing member according to another embodiment of the present invention;

FIG. 6 is a bottom view of an insulating plate having a fixing member according to another embodiment of the present invention;

FIG. 7 is a bottom view of an insulating plate having a fixing member according to another embodiment of the present invention;

FIG. 8 is a partial cross-sectional view of a secondary battery equipped with an insulating plate having a fixing member according to another embodiment of the present invention;

FIG. 9 is a partial cross-sectional view of a secondary battery equipped with an insulating plate having a fixing member according to another embodiment of the present invention; and

FIG. 10 is a bottom perspective view showing the terminal plate of FIG. 9.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in an exemplary embodiment by using the same reference numeral and only constituent elements other than the constituent elements described in the exemplary embodiment will be described in other embodiments.

In a typical secondary battery, the top of the can is sealed with a cap assembly. The terminal plate of the cap assembly is welded to any one of the negative tab and the positive tab drawn out of the electrode assembly and electrically connected thereto.

However, in this configuration, the terminal plate may be separated from the bottom of an insulating plate since no provision is made to secure the terminal plate to the insulating plate. Therefore, it is difficult to firmly weld the terminal plate to any one of the negative tab and the positive tab, because the terminal plate is not fixed or secured in any manner.

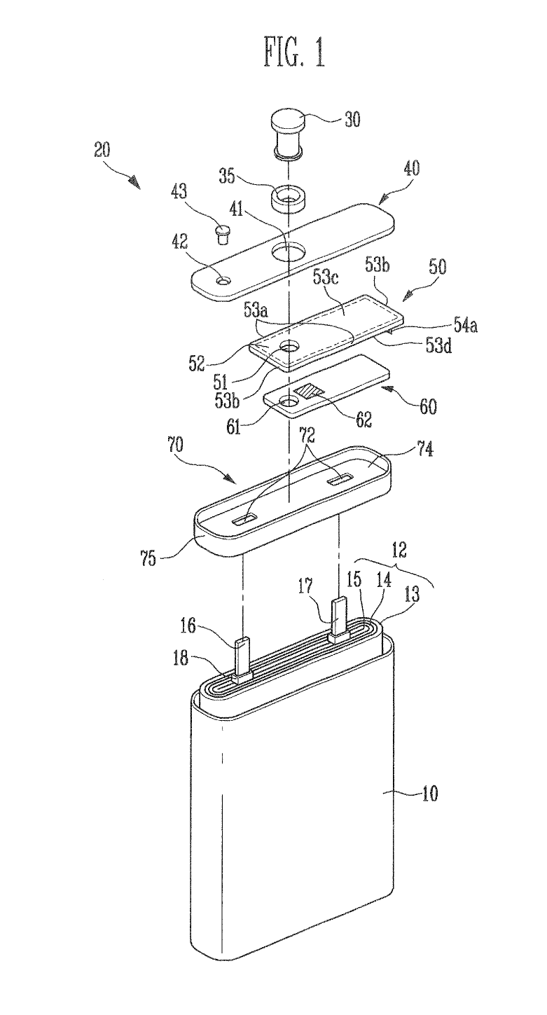

FIG. 1 is an exploded perspective view of a rectangular secondary battery according to an embodiment of the present invention.

Referring to FIG. 1, a secondary battery according to an embodiment of the present invention may include a can 10 having an opening at one side and accommodating an electrode assembly 12 and a cap assembly 20 sealing the opening of the can 10. Further, the secondary battery may include an insulating case 70 positioned between the electrode assembly 12 and the cap assembly 20 and placed on upper portion of the can 10.

In addition, the cap assembly 20 further may include a hook-shaped fixing member (latch, catch or fixing member) 54a formed on the bottom of the insulating plate 50 positioned between the cap plate 40 and the terminal plate 60. In this configuration, the hook-shaped fixing member 54a prevents the terminal plate 60 from coming apart by closely fixing the terminal plate 60 to the insulating plate 50.

The insulating plate 50 has a pair of long-sided surfaces 53a facing each other, a pair of short-sided surfaces 53b connecting the ends of the long-sided surfaces 53a, an upper surface 53c and a lower surface 53d. A receiving space 52 where the terminal plate 60 is inserted is formed on the bottom of the insulating plate 50. Further, the hook-shaped fixing member 54a is formed at the lower end of a side of the receiving space 52.

In this configuration, a second terminal hole 51 where an electrode terminal 30 is inserted is formed at a side of the insulating plate 50. Further, the fixing member 54a may be formed at the lower end of at least any one of the sides of the receiving space 52, at the other side of the insulating plate 50.

For convenience of description, the side at the long-sided surfaces 53a of the insulating plate 50 is referred to as a ‘long side wall’ and the side at the short-sided surfaces 53b of the insulating plate 50 is referred to as a ‘short side wall’.

The fixing member 54a according to an embodiment of the present invention is formed at the lower end of the short side wall at the other side of the insulating plate 50. That is, the fixing member 54a has a hook shape protruding inside the insulating plate 50, from a region of the lower end of the short side wall. Accordingly, the terminal plate 60 is attached by the fixing member 54a in close contact with the receiving space 52 of the insulating plate 50.

In this configuration, a fuse 62 may be further provided on the top of the terminal plate 60 and the length of the terminal plate 60 is increased by providing the fuse 62. Therefore, the end of the terminal plate 60 contacting the receiving space 52 of the insulating plate 50 may come undone or detach with the increase of the length of the terminal plate, but this is prevented by the fixing member 54a.

The configuration of the rectangular secondary battery is described hereafter in detail.

First, the electrode assembly 12 is formed by winding a negative plate 15 and a positive plate 13 with a separator 14 therebetween. A negative tab 16 may be connected to the negative plate 15, protruding upward from the electrode assembly 12, and a positive tab 17 may be connected to the positive plate 13, protruding upward from the electrode assembly 12. The negative tab 16 and the positive tab 17 are spaced apart from each other at a predetermined distance and electrically connected in the electrode assembly 12.

Further, a lamination tape 18 may be wound at the portion where the negative tab 16 and the positive tab 17 are drawn from the electrode assembly 12. The lamination tape 18 blocks heat generated from the negative plate 16 or the positive plate 17. Further, the lamination plate 18 prevents the electrode plate 12 from being pressed by the edges of the negative tab 16 and the positive tab 17.

In this configuration, the negative tab 16 and the positive tab 17 are electrically connected with the negative plate 15 and the positive plate 13 of the electrode assembly, respectively, and drawn out to the opening of the can 10. For this configuration, the negative tab 16 and the positive tab 17 are electrically connected with the can or the terminal plate 60 through lead-through holes 72 of an insulating case 70 fixed to the upper portion of the electrode assembly 12 in the can 10.

The negative plate 15 and the positive plate 13 are formed by dry coating slurry on a thin aluminum layer and a thin copper layer, respectively. The slurry contains the active substances of the negative plate 15 and the positive plate 13 and a fixing agent bonding the active substances to the metal layer. A lithium-containing oxide is used as the negative active substance in lithium secondary batteries. Further, although the positive active substance may be anyone of hard carbon, soft carbon, graphite, and carbon substances, the present invention is not limited to those types of lithium secondary batteries.

The can 10 accommodates the electrode assembly through the opening and the horizontal cross section of the can 10 is formed in a rectangle with the corners rounded. The horizontal cross-sectional shape of the can 10 is not limited to the above, and though not shown, the horizontal cross-sectional shape of the can 10 may be a rectangle, an ellipse or other shape.

The can 10 may be preferably made of aluminum, an aluminum alloy or any other light tensile metal or material. Further, the can 10 may be manufactured easily using a deep drawing method.

The cap assembly 20 may include a cap plate 40, an electrode terminal 30, an insulating plate 50, a terminal plate 60, and a gasket 35. The cap plate 40 may define one side of the can 10 by sealing the opening of the can 10 when the cap assembly 20 and the can 10 are combined. For this configuration, the cap plate 40 may be attached to the opening of the can 10 by welding, etc. Further, the cap plate 40 is electrically connected with anyone of the negative tab 16 and the positive tab 17 drawn out through the lead-through holes 72 of the insulating case 70. Further, the cap plate 40 has a first terminal hole 41 for combination with a gasket 35 and an electrolyte inlet 42 for injecting an electrolyte. The electrolyte inlet 42 formed in the cap plate 40 is used as a channel for injecting an electrolyte into the can 10. Further, the electrolyte inlet 42 is sealed with a cap 43 after the electrolyte is injected.

The gasket 35 is provided to ensure insulation between the electrode terminal 30 and the cap plate 40. A center terminal hole 36 may be formed through the gasket 35 for combination with the electrode terminal 30 and the electrode terminal 30 is combined with the gasket 35 through the center terminal hole 36.

Further, the insulating plate 50 described above is interposed between the cap plate 40 and the terminal plate 60 for insulation. Further, a second terminal hole 51 where the electrode terminal 30 passes is formed through the insulating plate 50.

Still further, the terminal plate 60 is electrically connected with the electrode terminal 30 by the third terminal hole 61. Further, the terminal plate 61 is electrically connected with the either one of the negative tab 16 or the positive tab 17 which is not connected with the cap plate 40. That is, when the cap plate 40 is electrically connected with the negative tab 16, the terminal plate 60 is connected with the positive tab 17 and accordingly, electric connection between the electrode terminal 30 and the positive tab 17 can be achieved.

The insulating case 70 may be positioned between the electrode assembly 12 and the cap assembly 20 for electric insulation, and in detail, it is kept inserted in the upper portion of the can 10. The insulating case 70 may be made of hard plastic resin having excellent electrical insulation properties. Therefore, when the insulating case 70 is inserted in the can 10, it is not substantially deformed by the electrolyte and it is easy to ensure insulation between the electrode assembly 12 and the cap assembly 20.

As described above, when the insulating case 70 is made of hard plastic resin, it is difficult to combine it with the can 10 due to its inelasticity. To eliminate this problem, the insulating case 70 may be composed of a base 74 and a support 75 to be stably connected with the can 10. In this configuration, the base 74 is the bottom of the insulating case 70 and the support 75 is the outer side of the insulating case 70.

The base 74 of the insulating case 70 is formed of a plate having a uniform thickness and has a shape similar to the horizontal cross-sectional shape of the can 10, particularly the cross-sectional shape of the other space except for the space where the electrode assembly 12 is accommodated. Further, it is preferable that the base 74 of the insulating case 70 is a little larger than the cross section of the other space for press-fitting in the can 10. The electrolyte inlet (not shown) and the lead-through holes 72 are formed through the insulating case 70.

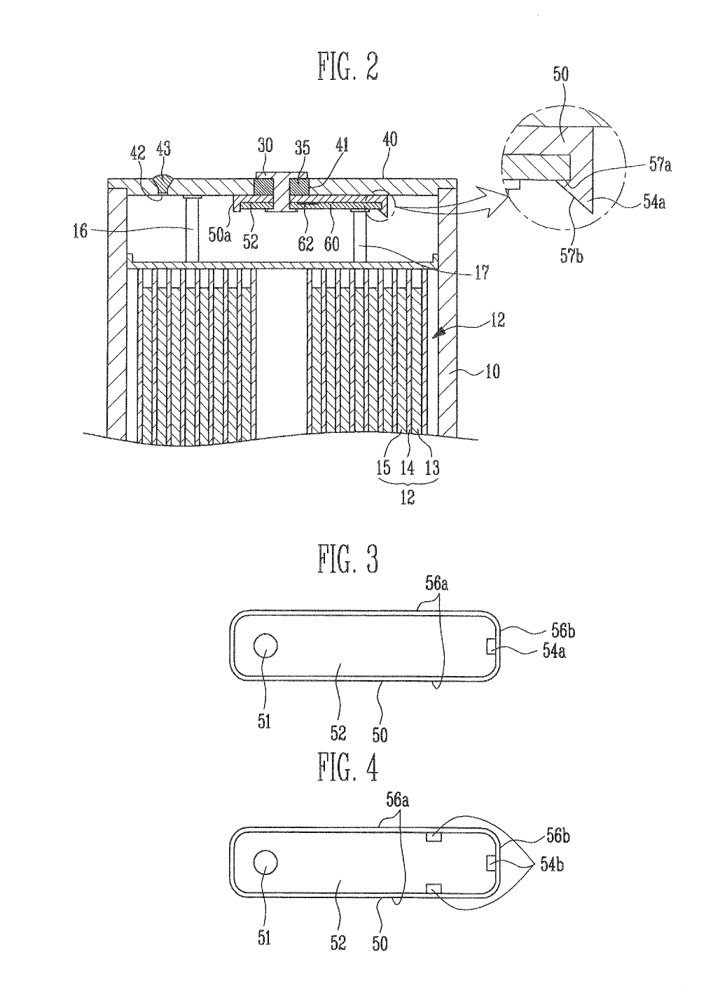

FIG. 2 is a partial cross-sectional view of a secondary battery equipped with the insulating plate having the fixing member according to an embodiment of the present invention and FIG. 3 is a bottom view of an insulating plate having the fixing member according to the embodiment of the present invention.

Referring to FIGS. 2 and 3, the insulating plate 50 according to an embodiment of the present invention is positioned between the cap plate 40 and the terminal plate 60, and has the receiving space 52 on the bottom to accommodate the terminal plate 60. Further, the fixing member 54a is formed opposite to the side of the insulating plate 50 where the second terminal hole 51 (see FIG. 1) is formed and where an insulating plate wall 50a is positioned, that is, on the side wall at the other side of the insulating plate 50. More preferably, the fixing member 54a is formed at the lower end of the short side wall 56a at the other side of the insulating plate 50.

The bottom of the fixing member 54a may be inclined upward to the inside of the insulating plate 50. Specifically, as shown in the magnified section of FIG. 2, the fixing member 54a is an extension of the insulating plate 50 having a traverse surface 57a that is parallel to the lower surface 53d of the insulating plate 50 and a tapered surface (camming surface) 57b inclined at an acute angle to the lower surface of the insulating plate. Accordingly, the end of the terminal plate 60 can be seated in the receiving space 52 without being locked to the bottom of the fixing member 54a, when the terminal plate 60 is press-fitted in the receiving space 52. Further, the elasticity of the fixing member 54a can be improved by this structure.

As described above, the end of the terminal plate 60 of which the length is increased by the fuse 62 (see FIG. 1) can be easily fixed to the receiving space 52 of the insulating plate 50 by the fixing member 54a. Therefore, it is possible to improve weldability between the terminal plate 60 and the positive tab 17 electrically and physically connected with the terminal plate 60.

Although one fixing member 54a is formed at the lower end of the short side wall 56b at the other side of the insulating plate 50 in the present embodiment of the present invention, more fixing members may be formed.

FIG. 4 is a bottom view of an insulating plate having a fixing member according to another embodiment of the present invention.

Referring to FIG. 4, the receiving space 52 where the terminal plate 60 (see FIG. 1) is formed on the bottom of the insulating plate 50. In this configuration, the receiving space 52 is slightly larger than the terminal plate 60 while covering the top and all the sides of the terminal plate 60. Further, the fixing member 54b are formed at the lower ends of a pair of long side walls 56a and one short side wall 56b at the other side of the insulating plate 50.

The end of the terminal plate 60 is fixed at three sides by the fixing member 54b, such that it is possible to firmly fix the terminal plate 60 to the receiving space 52 (see FIG. 1) of the insulating plate 50.

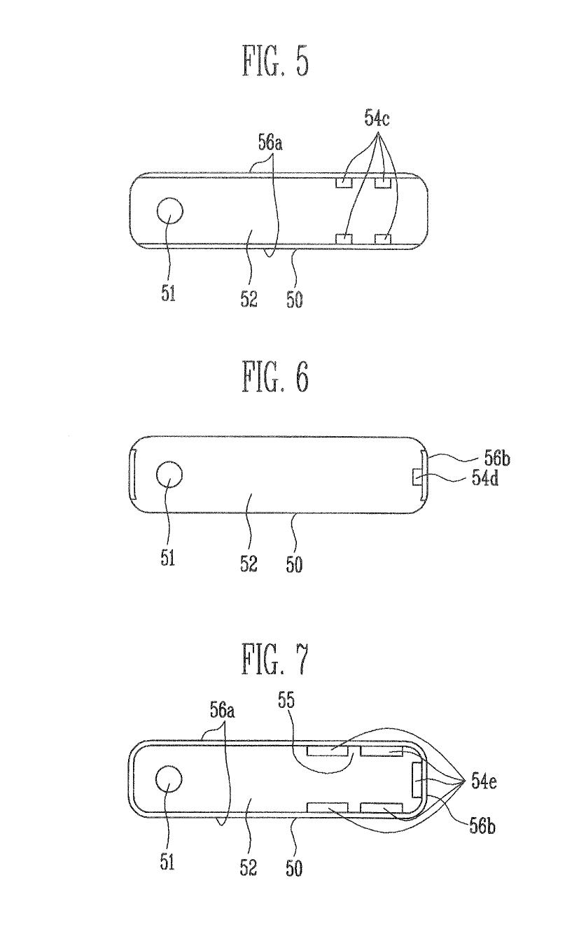

FIG. 5 is a bottom view of an insulating plate having a fixing member according to another embodiment of the present invention.

Referring to FIG. 5, a receiving space 52 is formed on the bottom of the insulating plate 50 to cover the top of the terminal plate 60 and only a pair of long side surfaces. That is, the receiving space 52 has only a pair of long side surfaces 56a.

Accordingly, two fixing members 54c fixing the end of the terminal plate 60 may be formed at the lower ends of the pair of long side walls 56a at the other side of the insulating plate 50, respectively. In this configuration, it is possible to more firmly fix the terminal plate 60, as compared with when one fixing member 54c is formed at one side.

FIG. 6 is a bottom view of an insulating plate having a fixing member according to another embodiment of the present invention.

Referring to FIG. 6, on the contrary to the embodiment shown in FIG. 5, a receiving space 52 is formed to cover the top of the terminal plate 60 (see FIG. 1) and only a pair of short side surfaces are provided. That is, the receiving space 52 has only a pair of short side walls 56b.

Therefore, a fixing member 54d may be formed in a hook shape protruding from the bottom of one short side wall 56b at the other side of the insulating plate 50.

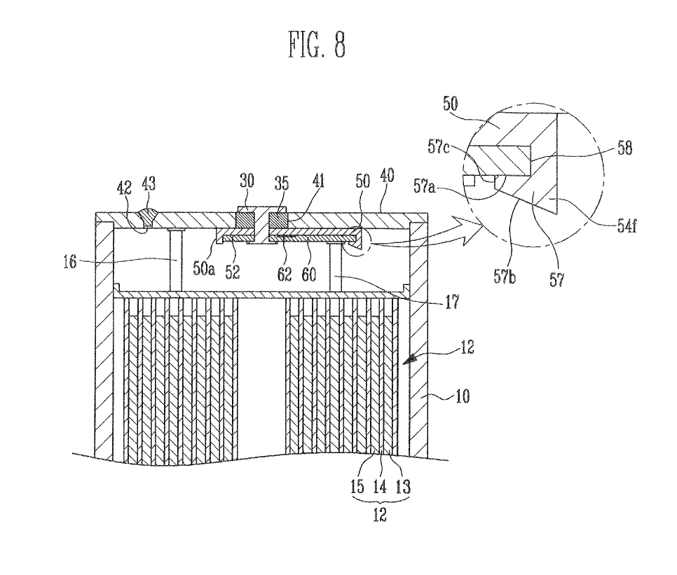

FIG. 7 is a bottom view of an insulating plate having a fixing member according to another embodiment of the present invention.

Referring to FIG. 7, a receiving space 52 formed on the bottom of the insulating plate 50 covers the top of the terminal plate 60 (see FIG. 1) and all of the sides. Further, the fixing members 54e are formed at a pair of long side walls 56a and one short side wall 56b at the other side of the insulating plate 50.

Unlike the previous embodiments described above, the fixing member 54e according to the embodiment of the present invention shown in FIG. 7 is formed longer along the short side wall 56b. Further, the fixing members 54e are formed longer with a space 55 along a long side wall 56a, except for the ends of a pair of long side walls 56a contacting the short side wall 56b.

Similar to the embodiment shown in FIG. 4 of the present invention, since the end of the terminal plate 60 is fixed at three sides by the fixing member 54e, it is possible to more firmly fix the terminal plate 60.

FIG. 8 is a partial cross-sectional view of a secondary battery equipped with an insulating plate having a fixing member according to another embodiment of the present invention.

Referring to FIG. 8, a support 57 extending inside the insulating plate 50 is formed at a predetermined region of the lower end of the short side wall of the insulating plate 50. That is, the support 57 is formed to support the bottom of the lower end of the terminal plate 60. The support 57 includes a traverse surface 57a that is parallel to the lower surface of the insulating plate 50 forming a guide groove 58 and a tapered surface 57b inclined at an acute angle to the lower surface of the insulating plate 50. The tapered surface 57b and the traverse surface 57a are connected by a perpendicular side wall 57c which is perpendicular to the lower surface 53d of the insulating plate 50. A guide groove 58 may be formed on the side of the short side wall of the insulating plate 50 by forming the support 57. In this configuration, the guide groove 58 is a space surrounded by the receiving space 52 of the insulating plate 50 and the support 57.

Further, a fixing member 54f having a hook shape protruding inside the insulating plate 50 is formed on the bottom of the support 57. In this configuration, the support 57 of the insulating plate 50 and the fixing member 54f may be made of an elastic material in order not to interfere with fastening the terminal plate 60. Further, since the fixing member 54f have a hook shape, it is possible to easily insert the terminal plate 60 into the guide groove 58. As described above, as the end of the terminal plate 60 is fitted in the guide groove 58, it is possible to prevent the end of the terminal plate 60 from coming undone or detached.

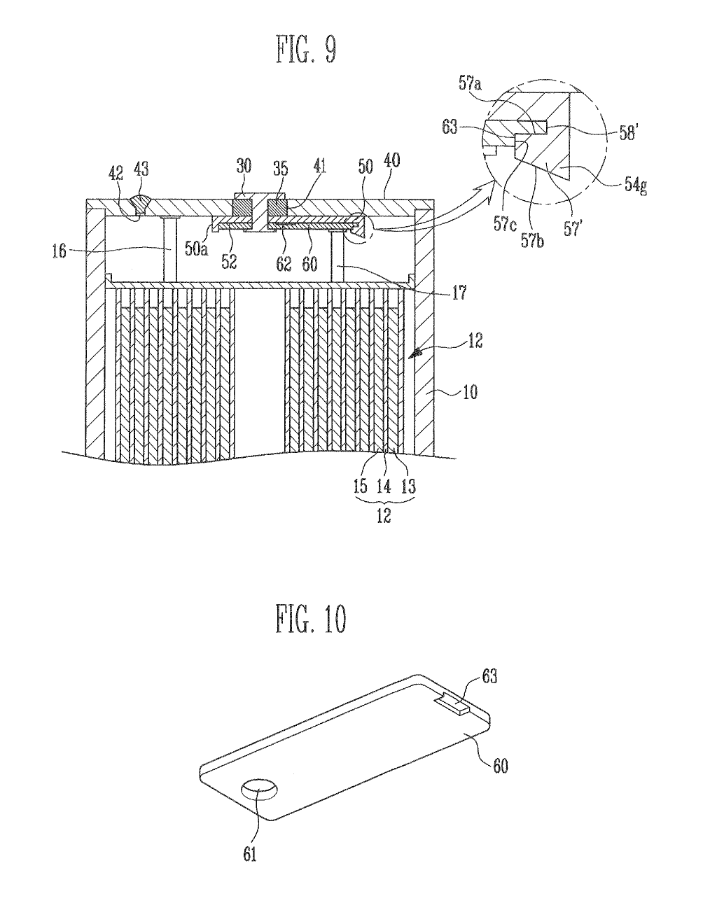

FIG. 9 is a partial cross-sectional view of a secondary battery equipped with an insulating plate having a fixing member according to another embodiment and FIG. 10 is a bottom perspective view showing the terminal plate of FIG. 9.

Referring to FIGS. 9 and 10, a support 57′ extending inside the insulating plate 50 is further formed, as in the embodiment illustrated in FIG. 6 of the present invention. In this configuration, the thickness of the space which is formed by the support 57′ and where the end of the terminal plate 60 is placed is smaller than the terminal plate 60. The support 57′ includes a traverse surface 57a that is parallel to the lower surface of the insulating plate 50 forming a guide groove 58′ and a tapered surface 57b inclined at an acute angle to the lower surface of the insulating plate 50. The tapered surface 57b and the traverse surface 57a are connected by a perpendicular side wall 57c which is perpendicular to the lower surface 53d of the insulating plate 50. Further, a locking groove 63 may be formed on the bottom of the terminal plate 60 to have a depth as much as the difference of the thicknesses. The locking groove 63 abuts against the perpendicular side wall 57c. Further, a fixing member 54g having a hook shape protruding inside the insulating plate 50 may be formed on the bottom of the support 57′.

It is possible to prevent the terminal plate 60 from horizontally moving, by forming the locking groove 63 on the bottom of the terminal plate 60 which contacts the support 57′ of the insulating plate 50 at the perpendicular side wall 57c. Further, it is possible to more firmly retain the terminal plate 60 both in an up/down or vertical direction as well as a left/right or horizontal direction.

Although a secondary battery including the terminal plate of which the length is increased by forming the fuse is described in the embodiments of the present invention, the present invention can be applied to secondary batteries including a terminal plate without a fuse.

Although the spirit of the present invention was described in detail with reference to the preferred embodiments, it should be understood that the embodiments are provided only for explaining the present invention and the present invention is not limited thereto. Further, it will be understood by those skilled in the art that the present invention may be modified in various ways within the scope of the present invention.

What is claimed is:

1. A cap assembly having a cap plate attached to an insulating case of a secondary battery, comprising:
a terminal plate positioned between the cap plate and the insulating case;
an insulting plate having an upper surface facing the cap plate and a lower surface facing a base of the insulating case; and
at least one fixing member extending from the lower surface of the insulating plate holding the terminal plate to the insulating plate.

2. The cap assembly recited in claim 1, wherein the at least one fixing member is hook-shaped.

3. The cap assembly recited in claim 2, wherein the insulating plate having four edges, said four edges including two long side surfaces and two short side surfaces.

4. The cap assembly recited in claim 3, wherein said at least one fixing member extends from the lower surface of the insulating plate opposite to a side surface where a hole is located near.

5. The cap assembly recited in claim 3, wherein the insulating plate having four edges, said four edges including two short side surfaces and no long side surfaces, wherein said at least one fixing member extends from the lower surface of the insulating plate nearest to one of the two short side surfaces and opposite to another side surface where a hole is located near.

6. The cap assembly recited in claim 3, comprised of at least two fixing members with one of the two fixing members being nearest to one of the two long side surfaces and another of the at least two fixing members being nearest to another of the two long side surfaces.

7. The cap assembly recited in claim 3, comprised of at least three fixing members with one of the three fixing members being nearest to one of the two long side surfaces, another of the at least three fixing members being nearest to another of the two long side surfaces and another of the at least three fixing members being nearest to one of the two short side surfaces.

8. The cap assembly recited in claim 1, wherein the at least one fixing member further comprises:
a support extending from the at least one fixing member to form a hook-shaped structure, wherein the support includes a traverse surface that is parallel to the lower surface of the insulating plate forming a guide groove and a tapered surface inclined at an acute angle to the lower surface of the insulating plate.

9. The cap assembly recited in claim 8, wherein the tapered surface and the traverse surface are connected by a perpendicular side wall which is perpendicular to the lower surface of the insulating plate.

10. The cap assembly recited in claim 9, wherein the terminal plate further comprises:
a locking groove recessed in the terminal plate having a shape to accommodate the support.

11. The cap assembly recited in claim 1, wherein the insulting plate further comprises:
a receiving space in the lower surface to accommodate the terminal plate.

12. The cap assembly recited in claim 1, wherein the insulating plate is partially surrounded by either the short side walls or the long side walls and fixing member extends from either the short side or long side walls.

13. A secondary battery having a cap assembly and a can, the cap assembly having a cap plate with an electrode terminal extending through the cap plate, the cap plate is attached to an insulating case, the insulating case is further attached to the can, the can having an electrolyte and an electrode assembly, the electrode assembly having a negative and positive tab, the cap assembly comprising:
a terminal plate having a second terminal hole through which the electrode terminal passes, the terminal plate is positioned between the cap plate and the insulating case;
an insulting plate having an upper surface facing and in contact with the cap plate and a lower surface in contact with the terminal plate and facing a base of the insulating case; and
at least one fixing member extending from the lower surface of the insulating plate holding the terminal plate to the insulating plate.

14. The secondary battery recited in claim 13, wherein the at least one fixing member is hook-shaped.

15. The secondary battery recited in claim 14, wherein the insulating plate having four edges, said four edges including two long side surfaces and two short side surfaces.

16. The secondary battery recited in claim 15, wherein said at least one fixing member extends from the lower surface of the insulating plate opposite to a side surface where a hole is located near.

17. The secondary battery recited in claim 15, wherein the insulating plate having four edges, said four edges including two short side surfaces and no long side surfaces, wherein said at least one fixing member extends from the lower surface of the insulating plate nearest to one of the two short side surfaces and opposite to another side surface where a hole is located near.

18. The secondary battery recited in claim 15, comprised of at least two fixing members with one of the two fixing members being nearest to one of the two long side surfaces and another of the at least two fixing members being nearest to another of the two long side surfaces.

19. The secondary battery recited in claim 15, comprised of at least three fixing members with one of the three fixing members being nearest to one of the two long side surfaces, another of the at least three fixing members being nearest to another of the two long side surfaces and another of the at least three fixing members being nearest to one of the two short side surfaces.

20. The secondary battery recited in claim 13, wherein the at least one fixing member further comprises:
a support extending from the at least one fixing member to form a hook-shaped structure, wherein the support includes a traverse surface that is parallel to the lower surface of the insulating plate forming a guide groove and a tapered surface inclined at an acute angle to the lower surface of the insulating plate.

21. The secondary battery recited in claim 20, wherein the tapered surface and the traverse surface are connected by a perpendicular side wall which is perpendicular to the lower surface of the insulating plate.

22. The secondary battery recited in claim 21, wherein the terminal plate further comprises:
a locking groove recessed in the terminal plate having a shape to accommodate the support.

23. The secondary battery recited in claim 13, wherein the insulting plate further comprises:
a receiving space in the lower surface to accommodate the terminal plate.

24. The secondary battery recited in claim 13, wherein the insulating plate is partially surrounded by either the short side walls or the long side walls and fixing member extends from either the short side or long side walls.
